(19) United States
(12) Patent Application Publication
(10) Pub. No.: US 2008/0059009 A1
(43) Pub. Date: Mar. 6, 2008

(54) SYSTEMS AND METHODS FOR INTERPLANETARY NAVIGATION

(75) Inventors: Neal R. Fedora, Clearwater, FL (US); Jeff Hegg, N. Reddington Beach, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/470,124

(22) Filed: Sep. 5, 2006

(51) Int. Cl. G01C 21/00; G06F 17/00

(52) U.S. Cl. 701/13; 701/200

(57) ABSTRACT

Systems and methods for interplanetary space navigation are provided. In one embodiment, a system for navigating a spacecraft in outer space is provided. The system comprises means for broadcasting navigation signals to a spacecraft traveling in outer space, each navigation signal comprising a spread-spectrum signal that includes information on the location of the means for broadcasting navigation signals, the time the navigation signal was transmitted and a reference frame identifier; means for receiving the navigation signals transmitted from the means for broadcasting navigation signals; and means for determining one or more ranges and delta-ranges between the means for receiving and the means for broadcasting based on the navigation signals using time-of-arrival (TOA) techniques; means for calculating a position of the spacecraft in space based on the one or more ranges; and means for calculating a velocity of the spacecraft in space based on the one or more delta-ranges.

### BACKGROUND

Spacecraft on deep space missions require periodic updates to ensure that they maintain a course that is consistent with their desired trajectory. Current deep space systems, such as the Deep Space Network (DSN) or the European Space Operations Centre (ESOC) comprise systems of ground based antenna arrays that are expensive to operate and maintain and require large areas of land to build. The Global Positioning System (GPS) is an example of an economical space based navigation system. However, GPS is only useful for terrestrial navigation because GPS satellites only direct navigation signals towards the Earth. Therefore GPS is not useful for navigating spacecraft on interplanetary missions.

For the reasons stated above and for other reasons stated below which will become apparent to those skilled in the art upon reading and understanding the specification, there is a need in the art for improved systems and methods for interplanetary navigation.

### SUMMARY

The Embodiments of the present invention provide methods and systems for improved interplanetary navigation and will be understood by reading and studying the following specification.

In one embodiment, a system for navigating a spacecraft in outer space is provided. The system comprises means for broadcasting navigation signals to a spacecraft traveling in outer space, each navigation signal comprising a spread-spectrum signal that includes information on the location of the means for broadcasting navigation signals, the time the navigation signal was transmitted and a reference frame identifier; means for receiving the navigation signals transmitted from the means for broadcasting navigation signals; and means for determining one or more ranges and delta-ranges between the means for receiving and the means for broadcasting based on the navigation signals using time-of-arrival (TOA) techniques; means for calculating a position of the spacecraft in space based on the one or more ranges; and means for calculating a velocity of the spacecraft in space based on the one or more delta-ranges.

### BRIEF DESCRIPTION OF THE DRAWINGS

Embodiments of the present invention can be more easily understood and further advantages and uses thereof more readily apparent, when considered in view of the description of the preferred embodiments and the following figures in which:

FIGS. 1A and 1B are block diagrams illustrating a space navigation system of one embodiment of the present invention;

FIGS. 2A and 2B are block diagrams illustrating a space navigation system of one embodiment of the present invention;

FIGS. 3A and 3B are block diagrams illustrating a space navigation system of one embodiment of the present invention; and

FIG. 4 is a flow chart illustrating a method for interplanetary space navigation of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

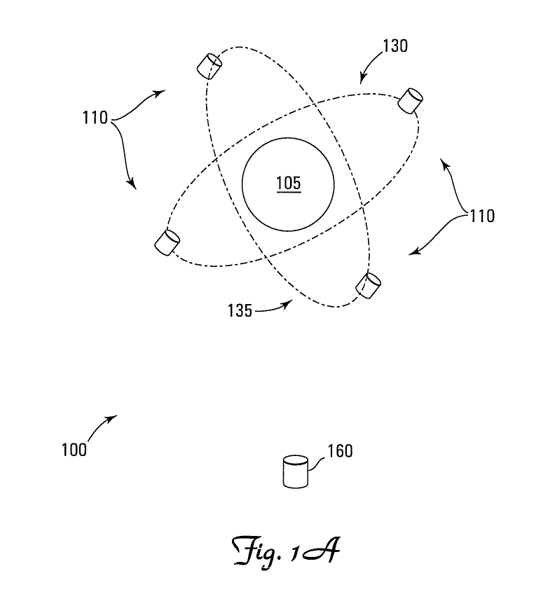

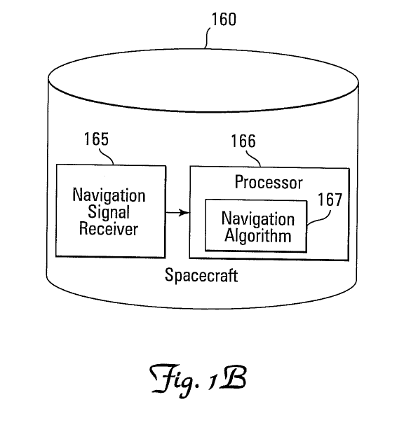

FIGS. 1A and 1B illustrate a space navigation system 100 of one embodiment of the present invention. Shown in FIG. 1A, system 100 comprises a set of navigation satellites (shown generally at 110) deployed in orbit around a celestial body 105. As used in this application, the term “celestial body” includes planets, moons, asteroids, or other bodies within Earth's solar system having sufficient gravity to hold a navigation satellite within an orbit. In one implementation of system 100, celestial body 105 is the Earth. In the embodiment illustrated in FIG. 1, satellites are deployed in both geo-synchronous orbits (shown generally at 130) and in polar orbits (shown generally at 135) around celestial body 105. In other embodiments, other orbital geometries may be used.

Each satellite of the set of navigation satellites 110 transmits one or more navigation signals into outer space having information that includes, but is not limited to, a reference frame identifier, the location of the satellite with respect to a known reference frame, and the time of transmission of the navigation signal. In one embodiment the satellites broadcast unencrypted spread-spectrum signals (such as those broadcast by global positioning system (GPS) satellites, for example) away from celestial body 105 out into space. The reference frame identifier identifies the frame of reference used by navigation satellites 110. The location information provided by the navigation signals indicate the location of the satellite with respect to the reference frame. For example, in one embodiment, the navigation signals indicate the location of the satellite with respect to a celestial body 105 based reference frame (for example, the longitude, latitude and altitude of the satellite). In one embodiment, signals from navigation satellites 110 also include information regarding the health status of a navigation satellite and/or information regarding the quality of the navigation information provided by the navigation satellite.

System 100 further comprises a spacecraft 160 including a navigation signal receiver 165, as shown in greater detail in FIG. 1B. Receiver 165 includes all the functionality required to receive the navigation signals transmitted by each satellite of the set of navigation satellites 110 and using time-of-arrival (TOA) techniques well known to those of ordinary skill in the art, calculate a range and delta-range measurement from spacecraft 160 to each of the satellites 110 from which a navigation signal was received. In one embodiment, spacecraft 160 further comprises a processor 166 implementing a navigation algorithm 167 (such as, but not limited to, a Kalman filter algorithm) that is programmed to receive the calculated range and delta-range data from navigation signal receiver 165 and provide a navigation solution that estimates the position of spacecraft 160 by further estimating any errors associated with the range data provided by navigation signal receiver 165. In such an embodiment, processor 166 is further programmed to incorporate this health and/or quality information in calculating the navigation solution.

In operation, when spacecraft 160 is at a sufficient distance from celestial body 105, the distance between each satellite of navigation satellites 110 becomes negligible when compared to the calculated range of spacecraft 160 from the navigation satellites 110 and the resulting Dilution of Precision (DOP) geometry is said to be “poor” or “weak” for the purposes of triangulation. As would be appreciated by one of ordinary skill in the art, DOP is a term used in geomatics engineering to describe the geometric strength of a satellite configuration. When navigation satellites as viewed from a spacecraft, such as spacecraft 160, are close together in the field of view, the geometry is said to be weak. In that case, ranges and delta-ranges calculated by navigation signal receiver 165 approximate the distance of spacecraft 160 from celestial body 105 itself. In one embodiment, by periodically verifying its own position and velocity with respect to its distance from celestial body 105, spacecraft 160 is enabled to ensure that it continues to travel along a desired trajectory.

When spacecraft 160 is in sufficient proximity to celestial body 105, the distances between each satellite of navigation satellites 110 are no longer negligible when compared to the calculated range of spacecraft 160 from the navigation satellites 110. The resulting DOP geometry is said to be “good” or “strong” for the purposes of triangulation. In that case, ranges calculated from each satellite of navigation satellites 110 can be used by spacecraft 160 to establish its own position and velocity with respect to relative location of celestial body 105. One of ordinary skill in the art would appreciate that by triangulating ranges between spacecraft 160 and at least three satellites of navigation satellites 110, navigation signal receiver 165 is enabled to calculate its own location in space with respect to a celestial body 105 based reference frame.

For example, in one embodiment, spacecraft 160 is traveling towards celestial body 105 with a mission to land on a specific target geographic location on the surface of celestial body 105. While approaching celestial body 105 from a distance, the satellite DOP geometry is not sufficient for triangulation. However, spacecraft 160 is able to periodically verify its distance and velocity from celestial body 105 to ensure that it remains on its desired trajectory. When spacecraft 160 reaches the near vicinity of celestial body, the satellite DOP geometry improves. Using navigation signals from navigation satellites 110, spacecraft 160 performs a triangulation computation to determine its relative position with respect to the surface of celestial body 105. By knowing its relative position, spacecraft 160 adjusts its position to navigate to the target geographic location.

It would be appreciated by one of ordinary skill in the art upon reading this specification that regardless of spacecraft's proximity to a celestial body having a set of navigation satellites, a navigation signal receiver on the spacecraft is always calculating the range and delta-range measurements between itself and individual satellites of the set of navigation satellites rather than directly calculating the distance between itself and the celestial body. One of ordinary skill in the art upon reading this specification would also readily be able to determine when the satellite DOP geometry of a set of navigation satellites is sufficiently strong to allow local navigation around a celestial body based on navigation signals from the set of navigation satellites. Further, one of ordinary skill in the art upon reading this specification would also readily be able to determine how frequently it is necessary for a spacecraft to recalculate the range and delta-range measurements based on the mission objectives of the spacecraft.

Embodiments of the present invention transmit navigation signals out into the vacuum of outer space and thus do not require as much transmission power as GPS signals transmitted by GPS satellites. It is not necessary to transmit through the lossy medium of the Earth's atmosphere because the receiver of the navigation signal is a spacecraft in space. For this reason, it is not necessary to transmit signals down towards earth. Satellites transmit the navigation signals in the direction of outer space meaning navigation signals are produced that travel away from the celestial body in which the satellite orbits. In one embodiment, transmitting navigation signals in the direction of outer space includes transmitting the navigation signals omni-directionally.

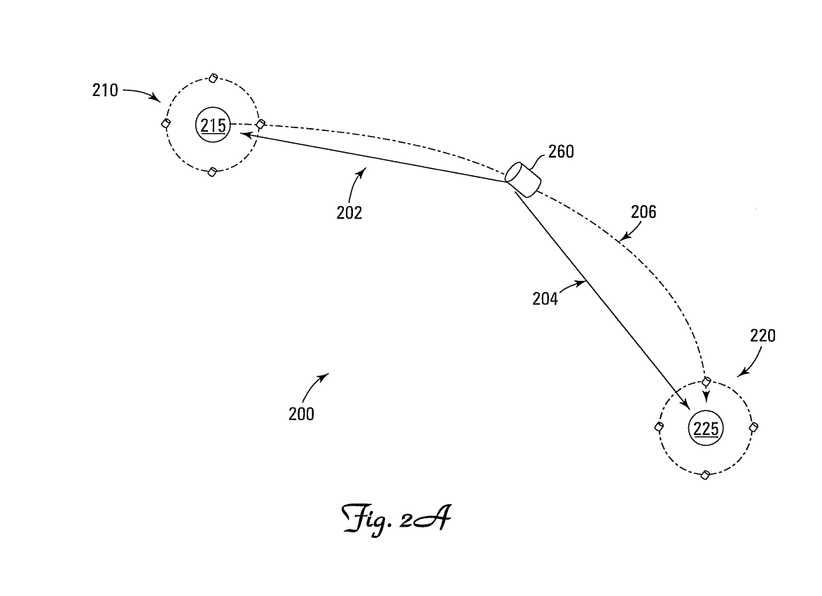

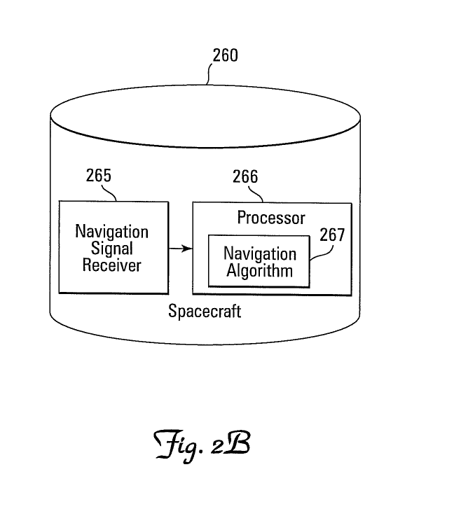

FIGS. 2A and 2B illustrate another space navigation system 200 of one embodiment of the present invention. Shown in FIG. 2A, system 200 comprises a first set of navigation satellites (shown generally at 210) deployed in orbit around a first celestial body 215, and a second set of navigation satellites (shown generally at 220) deployed in orbit around a second celestial body 225. In one embodiment, the first set of navigation satellites 210 and the second set of navigation satellites 220 include the same functionality and operate as described with respect to the set of navigation satellite 110 shown in FIG. 1. Each satellite of the set of navigation satellites 210 and 220 transmits one or more navigation signals having information that includes, but is not limited to, a reference frame identifier, the location of the satellite with respect to a known reference frame, and the time of transmission of the navigation signal. In one embodiment the navigation satellites 210 and 220 broadcast unencrypted spread-spectrum signals (such as those broadcast by global positioning system (GPS) satellites, for example) away from celestial bodies 215 and 225 respectively out into space. The location information provided by the navigation signals includes the satellites position in space with respect to a predefined reference frame.

In one embodiment, system 200 further comprises a spacecraft 260 traveling between the first celestial body 215 and the second celestial body 225 along a desired trajectory 206. As shown in FIG. 2B, spacecraft 260 includes a navigation signal receiver 265, a processor 266 and a navigation algorithm 267 that each include the same functionality described with respect to navigation signal receiver 165, processor 166 and navigation algorithm 167 shown in FIG. 1.

Navigation signal receiver 265 includes all the functionality required to receive navigation signals transmitted by each satellite of the first set of navigation satellites 210 and using time-of-arrival (TOA) techniques well known to those of ordinary skill in the art, calculate a first set of ranges and delta-ranges (shown generally at 202) from spacecraft 260 to each of those satellites orbiting first celestial body 215. Navigation signal receiver 265 also includes all the functionality required to receive navigation signals transmitted by each satellite of the second set of navigation satellites 220 and using time-of-arrival (TOA) techniques well known to those of ordinary skill in the art, calculate a second set of ranges and delta-ranges (shown generally at 204) from spacecraft 260 to each of those satellites orbiting first celestial body 225. Processor 266, implementing navigation algorithm 267 (such as, but not limited to, a Kalman filter algorithm), is programmed to receive the calculated range and delta-range data from navigation signal receiver 265 and provide a navigation solution that estimates the position and velocity of spacecraft 260 in space.

The reference frame identifier included in the navigation signals enables navigation signal receiver 265 to distinguish navigation signals received from navigation satellites 210 from navigation signals received from navigation satellites 220. The reference frame identifier allows navigation signal receiver 265 to establish which frame of reference each navigation signal received is based on. For example, in one embodiment, reference frame identifiers from navigation satellites 210 informs navigation signal receiver 265 that navigation signals from navigation satellites 210 are based on a celestial body 215 centric reference frame. Meanwhile, reference frame identifiers from navigation satellites 220 informs navigation signal receiver 265 that navigation signals from navigation satellites 220 are based on a celestial body 225 centric reference frame. With this information, processor 266 can transform the information received from the navigations signals into a common frame of reference for estimating the position and velocity of spacecraft 260 in space.

As explained above in FIG. 1, when the satellite DOP geometry between the satellites of navigation satellites 210 and spacecraft 260 is strong, triangulation techniques known to one of ordinary skill in the art can be used to establish the local position and velocity of spacecraft 260 with respect to the geography of celestial body 215 based on navigation signals from navigation satellites 210. Similarly, when spacecraft 260 is in sufficient proximity to celestial body 225, the satellite DOP geometry between the satellites of navigation satellites 220 and spacecraft 260 is strong and enables spacecraft 260 to establish its local position and velocity with respect to the geography of celestial body 225 based on navigation signals from navigation satellites 220.

The advantage of space navigation system 200 over space navigation system 100 becomes more apparent when spacecraft 260 is traveling through space at a significant distance from each of first celestial body 215 and second celestial body 225. In that case, navigation satellites 210 and navigation satellites 220 provide spacecraft 260 at least two reference points (i.e., the ranges 202 and 204 to first celestial body 215 and second celestial body 225, respectively) for verifying that it continues to travel along the desired trajectory 206 in space. As would be appreciated by one of ordinary skill in the art, the relative positions and paths traveled by celestial bodies orbiting in the Solar System is highly predictable and readily determined using techniques known to one of ordinary skill in the art. Therefore, by knowing the relative positions of first celestial body 215 and second celestial body 225 and the range from spacecraft 260 to each of first celestial body 215 and second celestial body 225, processor 266 can determine the position and velocity of spacecraft 260 with a sufficient accuracy for many applications.

For example, in one embodiment, spacecraft 260 is traveling from first celestial body 215 to a destination on second celestial body 225. Navigation signal receiver 265 receives navigation signals transmitted by satellites of the first set of navigation satellites 210. Using time-of-arrival techniques, navigation signal receiver 265 periodically calculates ranges and delta-ranges (shown generally at 202) between spacecraft 260 and navigation satellites 210. At the same time, navigation signal receiver 265 receives navigation signals transmitted by satellites of the second set of navigation satellites 220. Using time-of-arrival techniques, navigation signal receiver 265 periodically ranges and delta-ranges (shown generally at 204) between spacecraft 260 and navigation satellites 220. With knowledge of spacecraft 260's intended trajectory 260 and the relative positions of first celestial body 215 and second celestial body 225 in space, processor 266 compares the measured distances of navigation satellites 210 and navigation satellites 220 to expected ranges and delta-ranged to first celestial body 215 and second celestial body 225 for aiding the navigation solution. As previously mentioned, one of ordinary skill in the art upon reading this specification would be readily able to determine how frequently spacecraft 260 should re-calculate ranges and delta-ranges to navigation satellites 210 and navigation satellites 220 for navigation purposes.

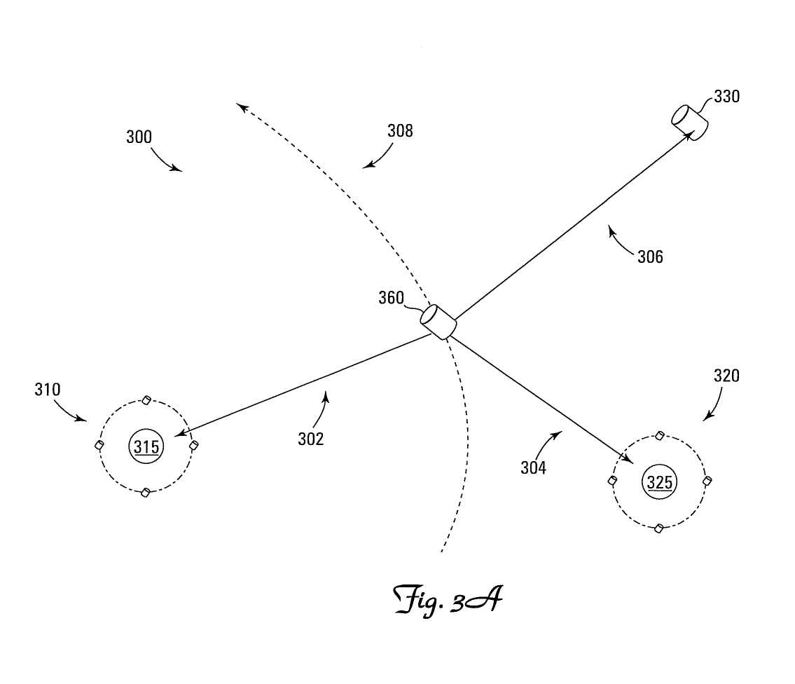

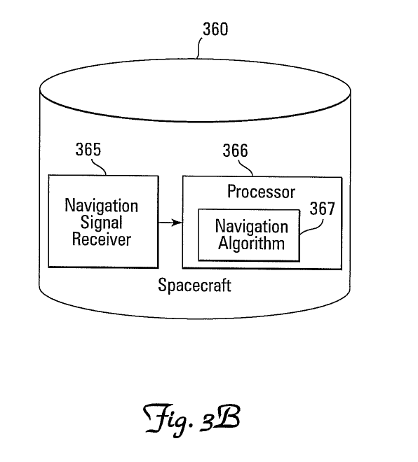

FIGS. 3A and 3B illustrate another space navigation system 300 of one embodiment of the present invention. As shown in FIG. 3A, in one embodiment, system 300 comprises a first set of navigation satellites (shown generally at 310) deployed in orbit around a first celestial body 315, and a second set of navigation satellites (shown generally at 320) deployed in orbit around a second celestial body 325. The first set of navigation satellites 310 and the second set of navigation satellites 320 include the same functionality and operate as described with respect to the set of navigation satellites 110 shown in FIG. 1 while also providing the ephemeris data of their respective celestial bodies relative to inertial space. Each satellite of the set of navigation satellites 310 and 320 transmits one or more navigation signals having information that includes, but is not limited to, a reference frame identifier, the location of the satellite with respect to a predefined reference frame, and the time of transmission of the navigation signal. In one embodiment the navigation satellites 310 and 320 broadcast unencrypted spread-spectrum signals (such as those broadcast by global positioning system (GPS) satellites, for example) away from celestial bodies 315 and 325 respectively out into space. As illustrated in FIG. 3, system 300 further includes at least one deep space navigational marker 330. Navigation marker 330 transmits into space one or more navigation signals having information that includes, but is not limited to, a reference frame identifier, the location of navigation marker 330 and the time of transmission of the navigation signal. In one embodiment navigation marker 330 broadcast unencrypted spread-spectrum signals (such as those broadcast by global positioning system (GPS) satellites, for example) out into space. In one embodiment, the navigation signals provide the location of navigation marker 330 with respect to an inertial reference frame (for example, its position in space relative to one or more celestial bodies) or other predefined reference frame. In one embodiment, navigation marker 330 is deployed at one of several known “Lagrange points” within the Solar System. As would be appreciated by one of ordinary skill in the art, at Lagrange points, gravitational fields created by two massive co-orbiting bodies combine with centrifugal forces of a third body, allowing the third body to appear stationary with respect to the first two bodies. In one such an embodiment, a navigation marker 330 provides its location as a position in space relative to at least one of the co-orbiting bodies associated with that particular Lagrange point.

As shown in FIG. 3B, system 300 further comprises a spacecraft 360 traveling in open space on a desired trajectory 308. Spacecraft 360 includes a navigation signal receiver 365 and a processor 366 implementing a navigation algorithm 367. Navigation signal receiver 365, processor 366 and navigation algorithm 367 each include the same functionality described with respect to navigation signal receiver 165 and processor 166 shown in FIG. 1. In one implementation, spacecraft 360 travels at significant distances from celestial bodies 315 and 325.

In operation, navigation signal receiver 365 receives navigation signals from navigation satellites 310, navigation satellites 320 and navigation marker 330. Using time-of-arrival (TOA) techniques well know to those of ordinary skill in the art, navigation signal receiver 365 calculates a set of ranges and delta-ranges (shown generally at 302) from spacecraft 360 to navigation satellites 310, a set of ranges and delta-ranges (shown generally at 304) from spacecraft 360 to navigation satellites 320, and a range and delta-range (shown generally at 306) from spacecraft 360 to navigation marker 330. The reference frame identifier included in the navigation signals enables navigation signal receiver 365 to distinguish navigation signals received from navigation satellites 310, navigation satellites 320 and navigation marker 330. The reference frame identifier allows navigation signal receiver 265 to establish which frame of reference each navigation signal received is based on. With this information, processor 366 can transform the information received from the navigations signals into a common frame of reference for estimating the position and velocity of spacecraft 360 in space.

Processor 366 receives the ranges and delta-ranges from navigation signal receiver 365 and using techniques known to one of ordinary skill in the art, calculates the position and velocity of spacecraft 360 in space by triangulating the ranges and delta-ranges from navigation satellites 310 and 320 and navigation marker 330. In one embodiment, processor 366 implements a navigation algorithm 367 (such as, but not limited to, a Kalman filter algorithm) that is programmed to receive the calculated range data from navigation signal receiver 365 and provide a navigation solution that estimates the position of spacecraft 360 by further estimating any errors associated with the range data provided by navigation signal receiver 365. In one embodiment, signals from navigation satellites 310, 320 and navigation marker 330 also include information regarding the health status of a navigation satellite and/or information regarding the quality of the navigation information provided by the navigation satellite. In such an embodiment, processor 366 is further programmed to incorporate this health and/or quality information in calculating the navigation solution.

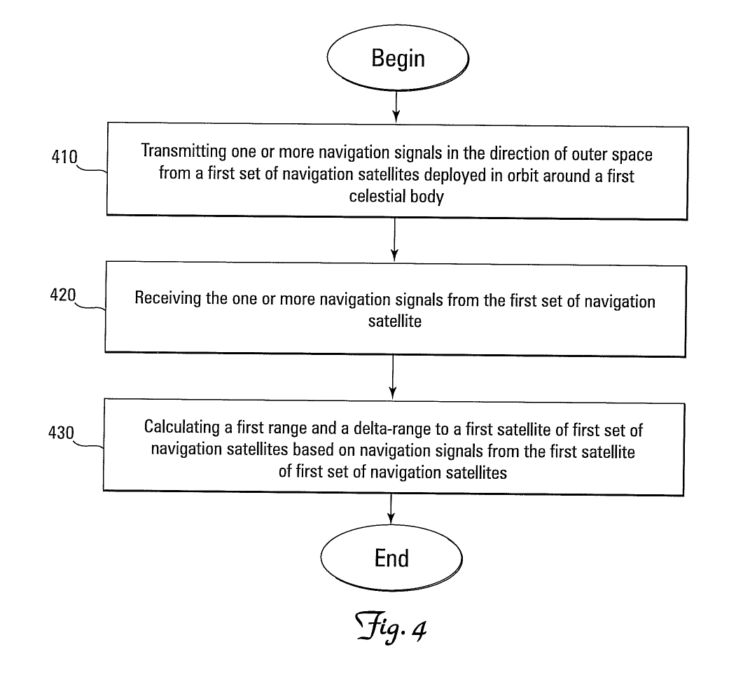

FIG. 4 is a flow chart illustrating a method of one embodiment of the present invention. The method begins at 410 with transmitting one or more navigation signals in the direction of outer space from a first set of navigation satellites deployed in orbit around a celestial body. Transmitting in the direction of outer space means transmitting the navigation signals so that navigation signals travel away from the celestial body. In one embodiment, transmitting in the direction of outer space means directing the transmission away from the celestial body. In one embodiment the satellites broadcast unencrypted spread-spectrum signals (such as those broadcast by global positioning system (GPS) satellites, for example) away from the celestial body into space. In one embodiment, a navigation signal from a satellite of the set of navigation satellites includes information such as, but not limited to, a reference frame identifier, the location of the satellite with respect to a predefined frame of reference, and the time of transmission of the navigation signal. In one embodiment, the navigation signal from the satellite provides the location of the satellite with respect to a celestial body based reference frame (for example, the longitude, latitude and altitude of the satellite). In one embodiment satellites of the first set of navigation satellites are deployed in geo-synchronous orbits around the celestial body. In one embodiment, the first set of navigation satellites include one or more satellites deployed in polar orbits around the celestial body. In other embodiments, different orbital geometries may be used.

The method proceeds to 420 with receiving one or more navigation signals from the first set of navigation satellites. In one embodiment, the navigation signals are received by a receiver located on a spacecraft. The method proceeds to 430 with calculating a range and delta-range to a first satellite of first set of navigation satellites based on the navigation signals. The range and delta-range between the spacecraft and the first satellite is calculated using time-of-arrival techniques known to those of ordinary skill in the art. In one embodiment, the method includes receiving navigation signals from a plurality of satellites of the first set of navigation satellites. In that case, the method proceeds with calculating the position and velocity of the spacecraft using a frame of reference with respect to the celestial body.

In one embodiment, the method further includes receiving one or more navigation signals from a second set of navigation satellites orbiting a second celestial body. In one such case, the method comprises calculating a first range and a first delta-range measurement to a first satellite of the first set of navigation satellites and a second range and a second delta range measurement to a first satellite of the second set of navigation satellites. The method then proceeds with calculating the relative position and velocity of the spacecraft in space based on the first and second range measurements, the first and second delta-range measurements, and the known positions of the first and second celestial bodies having navigation satellites. As previously discussed, the positions of celestial bodies orbiting within the Solar System are highly predicable and thus navigation satellites orbiting those celestial bodies provide highly accurate reference points for defining the relative position of a spacecraft traveling through space.

In one embodiment, the method further includes receiving one or more navigation signals from at least one navigation buoy located at a know position in space. In one such embodiment, the method comprises calculating a first range and delta-range to the first celestial body based on navigation signals from the first set of navigation satellites, calculating a second range and delta-range to the second celestial body based on navigation signals from the second set of navigation satellites, and calculating a third range and delta-range to the navigation buoy based on navigation signals from the navigation buoy. The method then proceeds with calculating the relative position and velocity of the spacecraft in space based on the first range and delta-range, the second range and delta-range, the third range and delta-range, the known positions of the first and second celestial bodies having navigation satellites, and the known position of the navigation buoy. In one embodiment, the at least one navigation buoy is deployed at a Lagrange point within the Solar System.

In other embodiments multiple sets of navigation satellites and navigation buoys are deployed through-out the Solar System enabling the spacecraft to determine its position based on navigation signals from any combination of the sets of navigation satellites and navigation buoys. In one embodiment, calculating the relative position of the spacecraft includes applying a navigation algorithm (such as, but not limited to a Kalman filter) to determine a navigation solution that incorporates estimated errors in the calculated range and delta-range measurements.

Several means are available to implement the systems and methods of the current invention as discussed in this specification. These means include, but are not limited to, digital computer systems, microprocessors, programmable controllers and field programmable gate arrays. Therefore other embodiments of the present invention are program instructions resident on computer readable media which when implemented by such controllers, enable the controllers to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for interplanetary navigation of a spacecraft, the method comprising:
transmitting one or more navigation signals in the direction of outer space from a first set of navigation satellites deployed in orbit around a first celestial body, the navigation signals including a reference frame identifier, a location, and a time of transmission;
receiving the one or more navigation signals from the first set of navigation satellites; and
calculating at least one of a first range to a first satellite of the first set of navigation satellites based on the one or more navigation signals and a first delta-range to the first satellite of the first set of navigation satellites based on the one or more navigation signals.

2. The method of claim 1, further comprising:
calculating at least two ranges to at least two satellites of the first set of navigation satellites;
calculating at least two delta-ranges to at least two satellites of the first set of navigation satellites; and
calculating at least one of a relative position of the spacecraft with respect to the first celestial object based on the at least two ranges and a relative velocity of the spacecraft with respect to the first celestial object based on the at least two delta-ranges.

3. The method of claim 1, wherein receiving the one or more navigation signals from the first set of navigation satellites further comprises:
receiving a first navigation signal from the first satellite of the first set of navigation satellites; and
determining a frame of reference based on the first navigation signal.

4. The method of claim 1, wherein calculating a range to a first satellite of first set of navigation satellites based on the navigation signals further comprises:
determining one or both of the location of the first satellite and a time of transmission of the navigation signal based on the navigation signal.

5. The method of claim 1, wherein calculating a range to a first satellite of first set of navigation satellites based on the navigation signals further comprises determining the range based on time-of-arrival techniques.

6. The method of claim 1, further comprising:
receiving one or more navigation signals from a second set of navigation satellites orbiting a second celestial body, wherein each satellite of the second set of navigation satellites is adapted to transmit one or more navigation signals in the direction of outer space; and
calculating at least one of a second range to a first satellite of the second set of navigation satellites based on navigation signals from the first satellite of second set of navigation satellites and a second delta-range to the first satellite of the second set of navigation satellites based on navigation signals from the first satellite of second set of navigation satellites.

7. The method of claim 6, further comprising:
distinguishing between navigation signals received from the first set of navigation satellites and the second set of navigation satellites based on the reference frame identifier.

8. The method of claim 6, further comprising:
calculating a relative position of the spacecraft with respect to the first celestial object and the second celestial object based on the first range and the second range.

9. The method of claim 6, further comprising:
calculating a relative velocity of the spacecraft with respect to the first celestial object and the second celestial object based on the first delta-range and the second delta-range.

10. The method of claim 1, further comprising:
receiving one or more navigation signals from a navigation marker, wherein each the navigation marker is adapted to transmit one or more navigation signals in the direction of outer space.

11. The method of claim 10, wherein receiving one or more navigation signals from a navigation buoy further comprises receiving one or more navigation signals from a navigation buoy deployed at a Lagrange point.

12. The method of claim 10, further comprising
calculating at least one of a third range to the navigation marker and a third delta-range to the navigation marker based on navigation signals from the navigation buoy; and

13. A spacecraft adapted for interplanetary travel, the spacecraft comprising:
a navigation signal receiver adapted to receive navigation signals broadcast to outer space from one or more of a set of navigation satellites and a navigation marker located in outer space, the navigation signal receiver further adapted to calculate one or more ranges and delta-ranges based on the navigation signals using time-of-arrival (TOA) techniques, wherein the navigation signals each include a reference frame identifier, a location, and a time of transmission; and
a processor coupled to the navigation signal receiver, the processor adapted to calculate a navigation solution that estimates one or both of a position and a velocity of the spacecraft based on the one or more ranges and delta-ranges.

14. The spacecraft of claim 13, wherein the processor is further adapted to implement a navigation algorithm programmed to receive the one or more ranges and delta-ranges and provide a navigation solution that estimates one or both of the position and the velocity of the spacecraft by further estimating errors associated with the one or more ranges and delta-ranges.

15. The spacecraft of claim 13, wherein the navigation signal receiver is further adapted to calculate a first range to a first celestial body based on at least one navigation signal received from a first navigation satellite of a first set of navigation satellites.

16. The spacecraft of claim 15, wherein the navigation signal receiver is further adapted to calculate a second range to a second celestial body based on at least one navigation signal received from a second navigation satellite of a second set of navigation satellites; and
wherein the processor is further adapted to calculate a position of the spacecraft in space based on the first range and the second range.

17. The spacecraft of claim 16, wherein the navigation signal receiver is further adapted to calculate a third range to a first navigation marker based on at least one navigation signal received from the first navigation marker; and
wherein the processor is further adapted to calculate a position of the spacecraft in space based on the first range, the second range and the third range.

18. The spacecraft of claim 13, wherein the processor is further adapted to determine if navigation corrections are required to stay on a desired course based on differences between the one or more ranges calculated by the navigation signal receiver and an expected range to one or more of a celestial body and a navigation buoy.

19. A system for navigating a spacecraft in outer space, the system comprising:
means for broadcasting navigation signals to a spacecraft traveling in outer space, each navigation signal comprising a spread-spectrum signal that includes information on the location of the means for broadcasting navigation signals, the time the navigation signal was transmitted and a reference frame identifier;
means for receiving the navigation signals transmitted from the means for broadcasting navigation signals; and
means for determining one or more ranges and delta-ranges between the means for receiving and the means for broadcasting based on the navigation signals using time-of-arrival (TOA) techniques;
means for calculating a position of the spacecraft in space based on the one or more ranges; and
means for calculating a velocity of the spacecraft in space based on the one or more delta-ranges.

20. The system of claim 19, wherein the means for broadcasting navigation signals includes a first means for broadcasting navigation signals in orbit around a first celestial body and at least one of:
a second means for broadcasting navigation signals around a second celestial body; and
a third means for broadcasting navigation signals deployed at a known location in outer space.
